(19) United States
(12) Patent Application Publication
(10) Pub. No.: US 2011/0071309 A1
(43) Pub. Date: Mar. 24, 2011

(54) Methods and Systems for Utilization of HCI

(76) Inventors: Brent R. CONSTANTZ, Portola Valley, CA (US); Brian Curtis, Los Gatos, CA (US)

(21) Appl. No.: 12/888,613

(22) Filed: Sep. 23, 2010

Related U.S. Application Data
(60) Provisional application No. 61/245,434, filed on Sep. 24, 2009.

(51) Int. Cl. C11C 1/02; B01J 19/08

(52) U.S. Cl. 554/163; 422/186

(57) ABSTRACT

Systems and methods are disclosed for generating a proton removing agent and an acidic solution in a low voltage electrochemical system and utilizing the proton removing agent to sequester carbon dioxide from a waste gas in a carbon dioxide sequestration system and utilizing the acidic solution to catalyze at least one step of a chemical syntheses in combination with a plant based material.

### CROSS-REFERENCE

This application is claims the benefit of U.S. Provisional Patent Application No. 61/245,434 filed on Sep. 24, 2009.

### BACKGROUND OF THE INVENTION

The present invention presents methods and systems for producing and utilizing an acid and proton removing agent generated in an electrochemical reaction. Proton removing agents may be used in some industrial processes, such as the sequestration of carbon dioxide. Acids may be a byproduct of electrochemical reactions used to create alkalinity for industrial process. Acids are important in the production of some biofuels. An acid, such as hydrochloric acid, may be used in a chemical synthesis reaction, such as in the production of cellulosic ethanol. The acid produced may be costly to dispose of. Methods are needed to efficiently and economically utilize acid produced in electrochemical reactions.

### SUMMARY OF THE INVENTION

The invention discloses methods and systems for utilizing reagents from an electrochemical reaction that include generating a proton removing agent and an acidic solution in the electrochemical reaction and sequestering a first portion of carbon dioxide from a waste gas in an aqueous solution by contacting the waste gas with the proton removing agent. In some embodiments the methods include contacting a plant based material and the acidic solution in a reaction mixture to catalyze at least one step of a chemical synthesis. In some embodiments, methods of this invention further comprise sequestering a second portion of carbon dioxide from the atmosphere in the plant based material via photosynthesis and calculating the sum of carbon dioxide sequestered in the first and second portion.

Other methods of the invention include utilizing reagents from an electrochemical reaction that comprises oxidizing hydrogen gas at an anode, generating a proton removing agent and an acidic solution in an electrochemical reaction. Utilizing reagents may include contacting a plant based material and the acidic solution in a reaction mixture to catalyze at least one step of a chemical synthesis. In some embodiments the chemical synthesis may be the synthesis of a biofuel.

In some embodiments the electrochemical reaction operates at a voltage of 2.0 volts or less. In some embodiments the pH of the acidic solution is less than 1. In some embodiments the electrochemical reaction is configured to avoid production of chlorine gas. In some embodiments the electrochemical reaction may include interposing an ion exchange membrane between an anode compartment comprising a gas diffusion anode and a cathode compartment comprising a catholyte in contact with a cathode in an electrochemical system and positioning a percolator in the anode compartment between the gas diffusion anode and the ion exchange membrane and percolating an anolyte through the percolator thereby establishing an ionic pathway from the anode to the cathode through the anolyte, the ion exchange membrane and the catholyte. The method may also include oxidizing hydrogen to protons at the gas diffusion anode and having the protons migrate into the percolator while generating a proton removing agent and hydrogen at the cathode by applying a voltage across the gas diffusion anode and cathode and migrating anions from the catholyte into the anolyte to form the acidic solution in the anolyte.

In some embodiments the acidic solution comprises an acid selected from hydrochloric acid, sulfuric acid, acetic acid, hydrofluoric acid, boric acid and nitric acid. In some embodiments the proton removing agent is sodium hydroxide. In some embodiments the plant based material comprises lignocellulosic material. In some embodiments the plant based material comprises plant oil. In some embodiments the chemical synthesis catalyzed comprises a chemical reaction selected from the group of transesterification, esterificaton and hydrolysis. In some embodiments the esterificaton comprises the esterificaton of free fatty acids. In some embodiments the transesterification reaction comprises the transesterification triglycerides. In some embodiments the transesterification reaction comprises transesterification of plant oil. In some embodiments the plant oil comprises used cooking oil. In some embodiments the plant oil has a free fatty acid concentration of greater than 6%. In some embodiments the chemical synthesis comprises digesting the lignocellulosic without the use of an enzyme.

Methods of this invention may further comprise precipitating a carbonate containing compound from the aqueous solution containing sequestered carbon dioxide. In some embodiments the precipitating comprises contacting the aqueous solution with a divalent cation. In some embodiments the acidic solution may be converted to a vapor prior to contacting with the plant based material. In some embodiments the concentration of the acidic solution is between 0.5 and 20.0 wt %. In some embodiments the pH of the reaction mixture may be raised after the catalyzing of the chemical synthesis. The pH may be raised by 1 or 2 or 3 or 4 or more pH points.

Systems of this invention may comprise an electrochemical system for generating a proton removing agent and acidic solution in an electrochemical reaction, a first reaction vessel operably connected to the electrochemical system for sequestering a first portion of carbon dioxide from a waste gas configured to contact an aqueous solution comprising the proton removing agent with the waste gas comprising carbon dioxide and a second reaction vessel operably connected to the electrochemical system for contacting a plant based material and the acidic solution to catalyze a chemical reaction. In some embodiments the second reaction vessel is configured to synthesize a biofuel. In some embodiments the second reaction vessel is configured to synthesize a furfural. In some embodiments the electrochemical system is configured to operate at a voltage of 2.0 volts or less. In some embodiments the electrochemical system is configured to avoid production of chlorine gas. In some embodiments the electrochemical system may comprise an ion exchange membrane interposed between an anode compartment comprising a gas diffusion anode and a cathode compartment comprising a catholyte in contact with a cathode, a percolator positioned in the anode compartment between the gas diffusion anode and the ion exchange membrane and configured to percolate an anolyte axially through the percolator, a voltage supply connected to the anode and cathode and operable to cause: oxidation of hydrogen to protons at the gas diffusion anode; migration of anions from the catholyte into the anolyte or migration of cations from the anolyte into the catholyte, through the ion exchange membrane; migration of the protons into the percolator to produce an acid in the anolyte in the percolator; and generation of hydroxide ions and hydrogen at the cathode to form an alkaline solution in the catholyte and a source of carbon dioxide configured to dissolve carbon dioxide to the catholyte and sequester the carbon dioxide as a carbonate and/or bicarbonate. In some embodiments the synthesis catalyzed in the second reaction vessel is configured to comprise a chemical reaction selected from the group of containing transesterification, esterification and hydrolysis.

### BRIEF DESCRIPTION OF THE DRAWINGS

The novel features of the invention are set forth with particularity in the appended claims. A better understanding of the features and advantages of the invention will be obtained by reference to the following detailed description that sets forth illustrative embodiments, in which the principles of the invention are utilized, and the accompanying drawings of which:

FIG. 1 is a flow chart of an embodiment of the present system.

FIG. 2 is a schematic diagram of an embodiment of the present system.

FIG. 3 is an illustration of an embodiment of an electrochemical component of the system.

FIG. 4 is a flow chart of an embodiment of the present system for synthesizing biodiesel.

### DETAILED DESCRIPTION OF THE INVENTION

For illustrative purposes and clarity the present invention, systems and methods are provided for generating a proton removing agent and an acidic solution in a low voltage electrochemical system and utilizing the proton removing agent to sequester carbon dioxide from an waste gas in a carbon dioxide sequestration system and the acidic solution to catalyze at least one step of a chemical syntheses in combination with a plant based material.

Before the invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrequited number may be a number, which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the invention, representative illustrative methods and materials are now described.

All publications, patents, and patent applications mentioned in this specification are incorporated herein by reference to the same extent as if each individual publication, patent, or patent application was specifically and individually indicated to be incorporated by reference. Furthermore, each cited publication, patent, or patent application is incorporated herein by reference to disclose and describe the subject matter in connection with which the publications are cited. The citation of any publication is for its disclosure prior to the filing date and should not be construed as an admission that the invention described herein is not entitled to antedate such publication by virtue of prior invention. Further, the dates of publication provided may be different from the actual publication dates, which may need to be independently confirmed.

It is noted that, as used herein and in the appended claims, the singular forms “a”, “an”, and “the” include plural references unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the invention. Any recited method can be carried out in the order of events recited or in any other order, which is logically possible.

Electrochemical and Biofuels combined Systems

The present invention provides systems and methods wherein acid is provided by a low voltage electrochemical method for use in the production of biofuels and other organic chemicals from carbon sequestering plant materials. The electrochemical method may also generate proton removing agents for a process that sequesters carbon dioxide from a waste gas. The methods and systems provided may beneficially and efficiently provide low cost reagents for processes that result in the reduced release of carbon dioxide into the atmosphere.

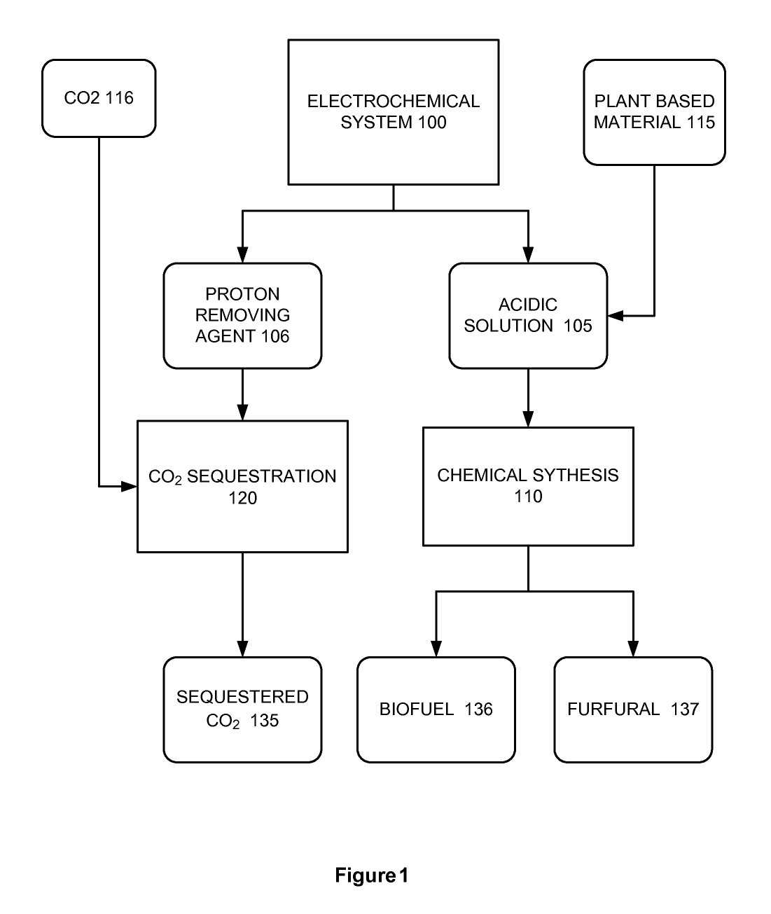

FIG. 1 is a schematic of one embodiment of the method of this in invention, in which an electrochemical system 100 that produces an acidic solution 105 and a proton removing agent 106 may be used to provide the acid catalyst for a chemical synthesis reaction 110 and a proton removing agent for a carbon sequestration process 120. The chemical synthesis 110 may utilize plant based materials 115 to generate biofuel 125 or furfural 126. In some embodiments, the proton removing agent 106 (e.g., hydroxide ions) generated by the electrochemical system 100 may be used to absorb carbon dioxide 120 using methods that include contacting a waste gas comprising carbon dioxide 116 with a proton removing agent 106. The C_{O2} absorption process 120 may generate a reaction product comprising carbonate, bicarbonate or any combination thereof in a carbon dioxide sequestration product 135. In some embodiments, the chemical synthesis process 110 may utilize plant based materials 115 and an acidic solution 105 from an electrochemical system 100 and generate biofuels 136 or furfural 137.

The chemical synthesis of useful materials from plant based materials may utilize acid for catalysis of one or more reactions involved in the process. In some embodiments the production of biofuels requires large amounts of acid for various processes. Some processes have used sulfuric acid because it may be an inexpensive alternative to hydrochloric acid. Hydrochloric acid may be used as well. Any acid generated by an electrochemical system may be useful for this invention (e.g., hydrochloric acid, sulfuric acid, acetic acid, hydrofluoric acid, bromic acid and nitric acid). It is useful to have a reliable source of acid in processes that require large amounts of acid. Certain processes, mentioned above, require concentrated acid. Some require fuming or vaporized acid.

In some embodiments, the electrochemical method is configured to avoid the production of chlorine gas. In some embodiments the electrochemical method is a low-voltage electrochemical method, e.g., a method that requires less than 2.0V or less than 1.5V, or in some embodiments less than 1.0V in order to produce the acid. In some embodiments of systems the present invention, a system for biofuel production is operably connected to an electrochemical system that produces an acid, such as hydrochloric acid (HCl) or sulfuric acid (H₂SO₄). For simplicity, the system will be described in terms of an embodiment wherein the electrochemical system produces HCl, however, it will be appreciated that the invention is not limited to such a system and includes low-voltage electrochemical systems that produce any acid, useable in a biofuels application, e.g., H₂SO₄, which is produced when, e.g., sodium sulfate is used. In such embodiments, systems that may be connected by pipelines, conduits, ground transportation transferring hydrochloric acid from the electrochemical system to the system for biofuel production. In some embodiments, an acid concentrator is operably connected to the system for biofuel production. In such embodiments, operably connected includes, but is not limited to, systems that are connected by pipelines, conduits, ground transportation transferring hydrochloric acid from the acid concentrator to the system for biofuel production. In some embodiments the acid produced by the electrochemical system is between 0.5 and 30.0 wt %. In some embodiments the acid produced by the electrochemical system is fed into the biofuel reaction system without additional processing such as concentration or dilution. In some embodiments the acid produced by the electrochemical system is diluted to less that 1 wt % prior to contact with a biofuel reaction system. In some embodiments the acid produced by the electrochemical system has a pH of less than 1. In some embodiments the acid produced by the electrochemical system has a pH of less than 2. In some embodiments, the hydrochloric acid produced is concentrated to a concentration of at least 2.8 M (moles per liter) or 10 wt % at 20° C. and atmospheric pressure. In some embodiments, the hydrochloric acid produced is concentrated to a concentration of at least 2.8 M (moles per liter) or 10 wt % at 20° C. and atmospheric pressure, such as at least 6.0 M (20 wt %), at least 9.5 M (30 wt %), at least 10.2 M(32 wt %), at least 10.9 M(34 wt %), at least 11.6 M (36 wt %), at least 12.4 M (38 wt %), or at least 12.9 M(40 wt %) HCl at 20° C. and atmospheric pressure. In some embodiments, the hydrochloric acid produced is concentrated to a concentration of at least 12.4 M (moles per liter) or 38 wt % at 20° C. and atmospheric pressure. In some embodiments, the hydrochloric acid produced is concentrated to a concentration of at least 12.9 M (moles per liter) or 40 wt % at 20° C. and atmospheric pressure. In some embodiments, the hydrochloric acid produced is concentrated to a concentration of at least 13.6 M (moles per liter) or 42 wt % at 20° C. and atmospheric pressure. In some embodiments the acid is concentrated by the use of an acid concentrator. In some embodiments, the acid concentrator is configured to produce hydrochloric acid concentrated to a concentration of at least 2.8 M (moles per liter) or 10 wt % at 20° C. and atmospheric pressure. In some embodiments, the acid concentrator is configured to produce hydrochloric acid concentrated to a concentration of at least 2.8 M (moles per liter) or 10 wt % at 20° C. and atmospheric pressure. In some embodiments, the acid concentrator is configured to produce hydrochloric acid concentrated to a concentration of at least 2.8 M (10 wt %), such as at least 6.0 M (20 wt %), such as at least 9.5 M (30 wt %), at least 10.2 M(32 wt %), at least 10.9 M(34 wt %), at least 11.6 M (36 wt %), at least 12.4 M (38 wt %), or at least 12.9 M(40 wt %) HCl at 20° C. and atmospheric pressure. In some embodiments, the acid concentrator is configured to produce HCl concentrated to a concentration of at least 12.4M (38 wt %) HCl at 20° C. and atmospheric pressure. In some embodiments, the acid concentrator is configured to produce HCl concentrated to a concentration of at least 12.9M (40 wt %) HCl at 20° C. and atmospheric pressure. In some embodiments, the acid concentrator is configured to produce HCl concentrated to a concentration of at least 13.6M (42 wt %) HCl at 20° C. and atmospheric pressure. In some embodiments, the acid concentrator is configured to produce HCl concentrated to a level at which the HCl is fuming at 20° C. and atmospheric pressure. In some embodiments, the acid concentrator is configured to produce HCl that is vaporized.

In some embodiments, the process for producing biofuel or furfural comprises hydrolysis of the biomass feedstock with hydrochloric acid. In some embodiments, the process for producing biofuel uses hydrochloric acid that is at a concentration of at least 1 wt % at 20° C. and atmospheric pressure. In some embodiments, the process for producing biofuel uses hydrochloric acid that is concentrated of at least 2.8 M (moles per liter) or 10 wt % at 20° C. and atmospheric pressure. In some embodiments, the process for producing biofuel uses hydrochloric acid concentrated to a concentration of at least 2.8 M (moles per liter) or 10 wt % at 20° C. and atmospheric pressure. In some embodiments, the process for producing biofuel uses hydrochloric acid concentrated to a concentration of at least 2.8 M (10 wt %), such as at least 6.0 M (20 wt %), such as at least 9.5 M (30 wt %), at least 10.2 M (32 wt %), at least 10.9 M (34 wt %), at least 11.6 M (36 wt %), at least 12.4 M (38 wt %), or at least 12.9 M(40 wt %) HCl at 20° C. and atmospheric pressure. In some embodiments, the process for producing biofuel uses HCl concentrated to a concentration of at least 12.4M (38 wt %) HCl at 20° C. and atmospheric pressure. hi some embodiments, the process for producing biofuel uses HCl concentrated to a concentration of at least 12.9M (40 wt %) HCl at 20° C. and atmospheric pressure. In some embodiments, the process for producing biofuel uses HCl concentrated to a concentration of at least 13.6M (42 wt %) HCl at 20° C. and atmospheric pressure. In some embodiments, the process for producing biofuel uses HCl concentrated to a level at which the HCl is fuming at 20° C. and atmospheric pressure. In some embodiments, the process for producing biofuel uses HCl that is vaporized. In some embodiments, the system for producing biofuel is configured to accept hydrochloric acid that is concentrated to a concentration of at least 1 wt % at 20° C. and atmospheric pressure. In some embodiments, the system for producing biofuel is configured to accept hydrochloric acid that is concentrated to a concentration of at least 2.8 M (moles per liter) or 10 wt % at 20° C. and atmospheric pressure. In some embodiments, the system for producing biofuel is configured to accept hydrochloric acid concentrated to a concentration of at least 2.8 M (10 wt %), such as at least 6.0 M (20 wt %), such as at least 9.5 M (30 wt %), at least 10.2 M(32 wt %), at least 10.9 M(34 wt %), at least 11.6 M (36 wt %), at least 12.4 M (38 wt %), or at least 12.9 M(40 wt %) HCl at 20° C. and atmospheric pressure. In some embodiments, the system for producing biofuel is configured to accept HCl concentrated to a concentration of at least 12.4M (38 wt %) HCl at 20° C. and atmospheric pressure. In some embodiments, the system for producing biofuel is configured to accept HCl concentrated to a concentration of at least 12.9M (40 wt %) HCl at 20° C. and atmospheric pressure. In some embodiments, the system for producing biofuel is configured to accept HCl concentrated to a concentration of at least 13.6 M(42 wt %) HCl at 20° C. and atmospheric pressure. In some embodiments, the system for producing biofuel is configured to accept HCl concentrated to a level at which the HCl is fuming at 20° C. and atmospheric pressure. In some embodiments, the system for producing biofuel comprises a system for recovering HCl.

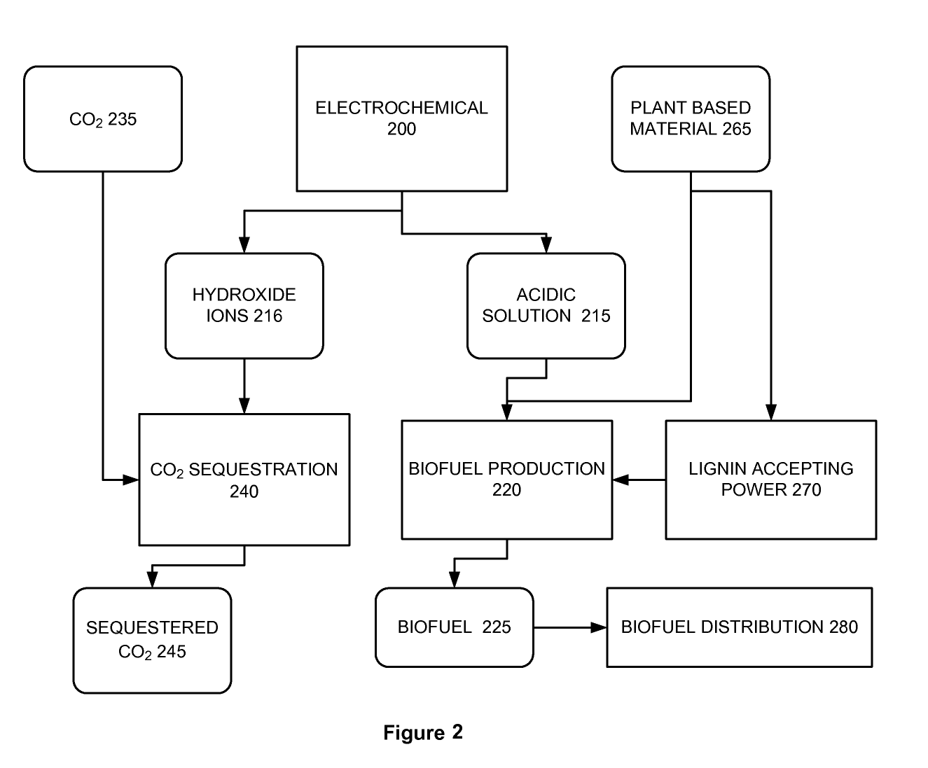

FIG. 2 is a schematic of one embodiment of the invention, in which an electrochemical system 200 produces an acidic solution 215 that is used by a biofuel production system 220 to produce biofuels 225. In some embodiments, the electrochemical system may also produce hydroxide ions 216 and may also be configured to be operably connected to reaction vessel for carbon dioxide sequestration 240 which is configured to accept carbon dioxide 235 and the hydroxide ions 216 produced by the electrochemical system 200. The CO₂ absorption system 240 may generate a reaction product comprising carbonate, bicarbonate or any combination thereof in a CO₂ sequestration product 245. In some embodiments, the system for biofuel production 220 is configured to receive plant based materials 265 and the acidic solution 215 from the electrochemical system 400 and generate biofuels 225 in a reaction vessel. In some embodiments, the system for biofuel production comprises a lignin accepting power system 270 that is used to power the activities of the biofuel production system 220. In some embodiments, the biofuels producing system 220 comprises a biofuel distribution system 280 that may comprise systems for bottling and shipping liquid biofuel. In some embodiments the carbon sequestration system may further comprise a reaction vessel for the precipitation of a carbonate and/or bicarbonate containing reaction product. In some embodiments any two or more connected systems may be co-located on the same plant. In some embodiments the carbon sequestration system may be co-located with a biofuel production system. In some embodiments the biofuel reaction vessel may be configured to produce bioethanol. In some embodiments the biofuel reaction vessel may be configured to produce furfural. In some embodiments the biofuel reaction vessel may be configured to produce biodiesel.

In some embodiments the electrochemical system may include an ion exchange membrane interposed between an anode compartment comprising a gas diffusion anode and a cathode compartment comprising a catholyte in contact with a cathode and a percolator positioned in the anode compartment between the gas diffusion anode and the ion exchange membrane and configured to percolate an anolyte axially through the percolator. A voltage supply may be connected to the anode and cathode and operable to cause the oxidation of hydrogen to protons at the gas diffusion anode and migration of anions from the catholyte into the anolyte or migration of cations from the anolyte into the catholyte, through the ion exchange membrane. The system may be configured to promote the migration of the protons into the percolator to produce an acid in the anolyte in the percolator and to generate hydroxide ions and hydrogen at the cathode to form an alkaline solution in the catholyte. The alkaline solution may be configured to dissolve carbon dioxide from a source of carbon dioxide and to sequester the carbon dioxide as a carbonate and/or bicarbonate. One or more reaction vessels of the system may be configured to promote the catalyzis of a synthesis synthesis reaction that comprises a chemical reaction such as transesterification, esterificaton or hydrolysis.

In some embodiments, the process for producing biofuel accepts at least 274,250 moles of acid per day. In some embodiments, the process for producing biofuel accepts at least 548,540 moles per day, such as at least 822,800 moles per day, at least 877,670 moles per day, at least 932,525 moles per day, at least 987,380 moles per day, at least 1,042,235 moles per day, at least 1,097,090 moles per day, at least 1,151,945 moles per day, at least 1,097,090 moles per day, at least 1,645,635 moles per day, at least 1,755,345 moles per day, at least 1,865,057 moles per day, at least 1,974,765 moles per day, 2,084,750 moles per day, at least 2,194,185 moles per day, at least 2,303,890 moles per day, at least 2,468,455 moles per day, at least 2,633,020 moles per day, at least 2,797,585 moles per day, at least 2,962,150 moles per day, at least 3,126,710 moles per day, at least 3,291,275 moles per day, or at least 3,455,840 moles per day of acid. In some embodiments, the process for producing biofuel accepts at least 3,455,840 moles of acid per day. In some embodiments, the process for producing biofuel accepts at least 5.2 billion moles of acid per day. In some embodiments, the process for producing biofuel accepts at least 7.3 billion moles of acid per day. In some embodiments, the system for producing biofuel is configured to accept at least 274,250 moles of acid per day. In some embodiments, the system for producing biofuel is configured to accept at least 548,540 moles per day, such as at least 822,800 moles per day, at least 877,670 moles per day, at least 932,525 moles per day, at least 987,380 moles per day, at least 1,042,235 moles per day, at least 1,097,090 moles per day, at least 1,151,945 moles per day, at least 1,097,090 moles per day, at least 1,645,635 moles per day, at least 1,755,345 moles per day, at least 1,865,057 moles per day, at least 1,974,765 moles per day, 2,084,750 moles per day, at least 2,194,185 moles per day, at least 2,303,890 moles per day, at least 2,468,455 moles per day, at least 2,633,020 moles per day, at least 2,797,585 moles per day, at least 2,962,150 moles per day, at least 3,126,710 moles per day, at least 3,291,275 moles per day, or at least 3,455,840 moles per day of acid. In some embodiments, the system for producing biofuel is configured to accept at least 3,455,840 moles of acid per day. In some embodiments, the system for producing biofuel is configured to accept at least 5.2 billion moles of acid per day. In some embodiments, the system for producing biofuel is configured to accept at least 7.3 billion moles of acid per day.

Sequestration of Carbon Dioxide

As described in commonly assigned U.S. patent application Ser. No. 12/344,019 supra, herein incorporated by reference, carbon dioxide can be sequestered by dissolving the gas in an aqueous solution Eq. I to produce aqueous carbon dioxide. This may be converted to carbonic acid, which will dissociate into bicarbonate ions and carbonate ions in accordance with Eq. II, depending on the pH of the solution when hydroxide ions are added to the solution Eq. III. The conversion of carbonic acid into bicarbonate and carbonate may be accomplished through the addition of a proton-removing agent (e.g., a base) (III-IV). Chemically, aqueous dissolution of CO₂ may be described by the following set of equations:

(I)

CO₂ (g)_{→}^{←}CO₂ (aq) (in the presence of water) (I)

(II)

CO₂ (aq)+H₂O_{→}^{←}H₂CO₃ (aq) (II)

Conversion to bicarbonate may described by the following equations:

(III)

H₂CO₃ (aq)+HO⁻(aq)_{→}^{←}HCO₃⁻(aq)+H₂O (III)

(IV)

CO₂(aq)+HO⁻(aq)_{→}^{←}HCO₃⁻(aq) (IV)

In the methods described herein, at least some of the captured carbon dioxide may be converted to bicarbonate or carbonate ions through the addition of proton-removing agents.

As described in detail below, contacting the alkaline solution with a source of CO₂ may employ any convenient protocol, such as for example by employing gas bubblers, contact infusers, fluidic Venturi reactors, spargers, components for mechanical agitation, stirrers, components for recirculation of the source of CO₂ through the contacting reactor, gas filters, sprays, trays, or packed column reactors, and the like, as may be convenient.

Aspects of the invention also include methods for contacting a solution with carbon dioxide to produce a carbon containing reaction product (e.g., an aqueous solution comprising carbonic acid, bicarbonate, carbonate or combination thereof). The reaction product may be a clear liquid. In some embodiments of methods of this invention, the gaseous reagent comprises CO₂ levels greater than those found in the atmosphere. A gas comprising CO₂ levels greater than those found in the atmosphere may be contacted with an aqueous mixture under conditions that do not include a flow of other gases that do not comprise CO₂. The aqueous mixture may be an alkaline solution. In certain embodiments of the invention, a portion of reaction product produced by contacting carbon dioxide with an alkaline solution may be further sequestered in a subterranean site, effectively sequestering carbon dioxide in the form of any combination of a carbonic acid, bicarbonate and carbonate mixture. Alternatively, or in addition to sequestering the reaction product, the carbonic acid, bicarbonate, carbonate, carbonate composition may further be contacted with a source of one or more proton-removing agents and/or a source of one or more divalent cations to produce a precipitated material comprising carbonates and/or bicarbonates. A portion of the precipitated material may be sequestered in a subterranean site or used as a building material. In some embodiments sequestering the reaction product may comprise placing the reaction product in a subterranean location.

“Alkaline solution” as used herein includes an aqueous composition which possesses sufficient alkalinity or basicity to remove one or more protons from proton-containing species in solution. Proton removing agents are discussed in greater detail below. The stoichiometric sum of proton-removing agents in the alkaline solution exceeds the stoichiometric sum of proton-containing agents. In some instances, the alkaline solution has a pH that is above neutral pH (i.e., pH>7), e.g., the solution has a pH ranging from 7.1 to 12, such as 8 to 12, such as 8 to 11, and including 9 to 11. For example, the pH of the alkaline solution may be 9.5 or higher, such as 9.7 or higher, including 10 or higher.

Adding hydroxide ions, for example, to a solution in the form of sodium hydroxide will promote the dissociation of dissolved carbonic acid into its ionic species will shift to the right; alternatively by adding protons to the solution an acid e.g., hydrochloric to the solution the speciation to the left. Thus, by regulating the pH of the solution, e.g., by adding sodium hydroxide to the solution, the carbon dioxide gas will be converted to a bicarbonate or bicarbonate, in accordance with Eq. III-IV thereby sequestering the gas since sodium carbonate or bicarbonate produced can be stored indefinitely is a stable-storage from.

As can be appreciated, other stable-storage carbonates and bicarbonate may be produced, including calcium and/or magnesium carbonate and/or bicarbonate, by adding the appropriate salt solution to replace the alkaline earth metals and preferentially precipitate the insoluble alkaline earth metal carbonate and/or bicarbonate over the more soluble alkaline metal carbonates and bicarbonates, as described in commonly assigned U.S. Pat. No. 7,735,274 supra.

### Materials

Carbon Dioxide

Methods of the invention include contacting a volume of a solution with a source of CO₂ to form a composition comprising water, carbonic acids, bicarbonates, or carbonates, or any combination thereof, wherein the composition is a solution, slurry, or solid material. In some embodiments, the resultant solution is subjected to conditions that induce precipitation of a precipitation material. The source of CO₂ may be any convenient source in any convenient form including, but not limited to, a gas, a liquid, a solid (e.g., dry ice), a supercritical fluid, and CO₂ dissolved in a liquid. In some embodiments, the CO₂ source is a gaseous CO₂ source. The gaseous stream may be substantially pure CO₂ or comprise multiple components that include CO₂ and one or more additional gases and/or other substances such as ash and other particulate material. In some embodiments, the gaseous CO₂ source is a waste feed (i.e., a by-product of an active process of the industrial plant) such as exhaust from an industrial plant. The nature of the industrial plant may vary, the industrial plants of interest including, but not limited to, power plants, chemical processing plants, mechanical processing plants, refineries, cement plants, smelters, steel plants, and other industrial plants that produce CO₂ as a by-product of fuel combustion or another processing step (such as calcination by a cement plant).

Waste gas streams comprising CO₂ include both reducing (e.g., syngas, shifted syngas, natural gas, hydrogen and the like) and oxidizing condition streams (e.g., flue gases from combustion). Particular waste gas streams that may be convenient for the invention include oxygen-containing combustion industrial plant flue gas (e.g., from coal or another carbon-based fuel with little or no pretreatment of the flue gas), turbo charged boiler product gas, coal gasification product gas, shifted coal gasification product gas, anaerobic digester product gas, wellhead natural gas stream, reformed natural gas or methane hydrates, and the like. Combustion gas from any convenient source may be used in methods and systems of the invention. In some embodiments, combustion gases in post-combustion effluent stacks of industrial plants such as power plants, cement plants, smelters, and coal processing plants is used.

Thus, the waste streams may be produced from a variety of different types of industrial plants. Suitable waste streams for the invention include waste streams produced by industrial plants that combust fossil fuels (e.g., coal, oil, natural gas) or anthropogenic fuel products of naturally occurring organic fuel deposits (e.g., tar sands, heavy oil, oil shale, etc.). In some embodiments, a waste stream suitable for systems and methods of the invention is sourced from a coal-fired power plant, such as a pulverized coal power plant, a supercritical coal power plant, a mass burn coal power plant, a fluidized bed coal power plant. In some embodiments, the waste stream is sourced from gas or oil-fired boiler and steam turbine power plants, gas or oil-fired boiler simple cycle gas turbine power plants, or gas or oil-fired boiler combined cycle gas turbine power plants. In some embodiments, waste streams produced by power plants that combust syngas (i.e., gas that is produced by the gasification of organic matter, for example, coal, biomass, etc.) are used. In some embodiments, waste streams from integrated gasification combined cycle (IGCC) plants are used. In some embodiments, waste streams produced by Heat Recovery Steam Generator (HRSG) plants are used to produce compositions in accordance with systems and methods of the invention.

Waste streams produced by cement plants are also suitable for systems and methods of the invention. Cement plant waste streams include waste streams from both wet process and dry process plants, which plants may employ shaft kilns or rotary kilns, and may include pre-calciners. These industrial plants may each burn a single fuel, or may burn two or more fuels sequentially or simultaneously.

While industrial waste gas streams suitable for use in the invention contain carbon dioxide, such waste streams may, especially in the case of power plants that combust carbon-based fuels (e.g., coal), contain additional components such as water (e.g., water vapor), CO, NOₓ (mononitrogen oxides: NO and NO₂), SOₓ (monosulfur oxides: SO, SO₂ and SO₃), VOC (volatile organic compounds), heavy metals and heavy metal-containing compounds (e.g., mercury and mercury-containing compounds), and suspended solid or liquid particles (or both). Additional components in the gas stream may also include halides such as hydrogen chloride and hydrogen fluoride; particulate matter such as fly ash, dusts (e.g., from calcining), and metals including arsenic, beryllium, boron, cadmium, chromium, chromium VI, cobalt, lead, manganese, mercury, molybdenum, selenium, strontium, thallium, and vanadium; and organics such as hydrocarbons, dioxins, and polycyclic aromatic hydrocarbon (PAH) compounds. Suitable gaseous waste streams that may be treated have, in some embodiments, CO₂ present in amounts of 200 ppm to 1,000,000 ppm, such as 200,000 ppm to 1000 ppm, including 200,000 ppm to 2000 ppm, for example 180,000 ppm to 2000 ppm, or 180,000 ppm to 5000 ppm, also including 180,000 ppm to 10,000 ppm. Flue gas temperature may also vary. In some embodiments, the temperature of the flue gas is from 0° C. to 2000° C., such as from 60° C. to 700° C., and including 100° C. to 400° C.

Proton-Removing Agents

Methods of the invention include contacting a volume of a solution with a source of CO₂ to form a product mixture comprising an aqueous composition including carbonic acid, bicarbonate, carbonate, or any combination thereof, wherein the mixture may be a solution, slurry, or a solid material. In some embodiments the solution may be alkaline. In some embodiments, the resultant product mixture is prepared for injection into a subterranean location. In some embodiments, the resultant product mixture is subjected to conditions that induce precipitation of a precipitation material. The dissolution of CO₂ into the aqueous solution of cations may produce carbonic acid, a species in equilibrium with both bicarbonate and carbonate. In order to produce some compositions of the invention, protons may be removed from various species (e.g., carbonic acid, bicarbonate, hydronium, etc.) in the solution to shift the equilibrium toward bicarbonate or carbonate. As protons are removed, more CO₂ goes into solution. In some embodiments, proton-removing agents and/or methods are used while contacting a cation-containing aqueous solution with CO₂ to increase CO₂ absorption in one phase of the reaction, where the pH may remain constant, increase, or even decrease, followed by a rapid removal of protons (e.g., by addition of a base) to cause rapid formation of compositions of the invention. Protons may be removed from the various species (e.g., carbonic acid, bicarbonate, hydronium, etc.) by any convenient approach, including, but not limited use of waste sources of metal oxides such as combustion ash (e.g., fly ash, bottom ash, boiler slag), cement kiln dust, and slag (e.g., iron slag, phosphorous slag), use of naturally occurring proton-removing agents, use of microorganisms and fungi, use of synthetic chemical proton-removing agents, recovery of man-made waste streams, alkaline brines, electrochemical means, and combinations thereof.

Electrochemical methods are another means to remove protons from various species in a solution, either by removing protons from solute (e.g., deprotonation of carbonic acid or bicarbonate) or from solvent (e.g., deprotonation of hydronium or water). Deprotonation of solvent may result, for example, if proton production from CO₂ dissolution matches or exceeds electrochemical proton removal from solute molecules. Alternatively, electrochemical methods may be used to produce caustic molecules (e.g., hydroxide) through, for example, the chlor-alkali process, or modification thereof. Electrodes (i.e., cathodes and anodes) may be present in the apparatus containing the cation-containing aqueous solution or gaseous waste stream-charged (e.g., CO₂-charged) solution, and a selective barrier, such as a membrane, may separate the electrodes. Electrochemical systems and methods for removing protons may produce by-products (e.g., hydrochloric acid) that may be harvested and used for other purposes. Additional electrochemical approaches that may be used in systems and methods of the invention include, but are not limited to, those described in U.S. patent application Ser. No. 12/344,019, filed 24 Dec. 2008; U.S. patent application Ser. No. 12/375,632, filed 23 Dec. 2008, International Patent Application No. PCT/US08/088242, filed 23 Dec. 2008; International Patent Application No. PCT/US09/32301, filed 28 Jan. 2009; International Patent Application No. PCT/US09/48511, filed 24 Jun. 2009; U.S. patent application Ser. No. 12/541,055 filed 13 Aug. 2009; and U.S. patent application Ser. No. 12/617,005, filed 12 Nov. 2009, the disclosures of which are incorporated herein by reference in their entirety. Combinations of any of the above mentioned sources of proton-removing agents and methods for effecting proton removal may also be employed.

Plant Based Biomass

“Biomass,” as used herein includes agricultural and forestry residues, municipal solid wastes, industrial wastes, and terrestrial and aquatic crops. Agricultural residues may include leftover material from crops, such as the stalks, leaves, and husks of corn plants. Forestry wastes may include chips and sawdust from lumber mills, dead trees, and tree branches. Municipal solid waste may include household garbage and paper products. Food processing and other industrial wastes may include black liquor, a paper manufacturing by-product or other byproducts of agricultural processes sing. Terrestrial crops may include fast-growing trees and grasses developed just for energy generation purposes, or conventional crops (e.g., corn, cotton, soybean, grapeseed linseed, jatropha palm etc. . . . ) from which oil may be harvested. Aquatic crops include algae grown in open loop or closed loop systems.

Algae may produce up to 300 times more oil per acre than conventional crops. Algae may have a harvesting cycle of 1-10 days or less, thus permitting several harvests in a very short time frame. Algae may also be grown on land that is not suitable for other established crops, for instance, arid land, land with excessively saline soil, and drought-stricken land. This may minimize the issue of taking away pieces of land from the cultivation of food crops. Algae may grow 20 to 30 times faster than food crops. Algae may be cultivated by pumping nutrient-laden water through plastic tubes (called “bioreactors”) that are exposed to sunlight (and so called photobioreactors or PBR). There is also a need to provide concentrated CO₂ to increase the rate of production.

In some embodiments the algae may be Cyanobacteria from the phylum of prokaryotic aguatic bacteria that obtain their energy through photosynthesis. They are often referred to as blue-green algae. Cyanobacteria may be single-celled or colonial. Depending upon the species and environmental conditions, colonies may form filaments, sheets or even hollow balls. Cyanobacteria are thus autotrophic producers of their own food from simple raw materials. Nitrogen-fixing cyanobacteria may need only nitrogen and carbon dioxide to live.

In a closed system (not exposed to open air) the system may advantageously reduce contamination by other organisms blown in by the air and CO₂ may be provided for alga growth from an industrial waste gas. Waste heat and CO₂ may be provided by an industrial source such as a power plant, cement plant, smelter or the like. In some embodiments a portion of the CO₂ from a single CO₂ generating plant may be directed towards algae cultivation and a portion may be directed to a CO₂ sequestering process. In some embodiments algae farming for biofuels may be done as part of cogeneration, where waste heat may be absorbed. In some embodiments of this invention, a portion of the CO₂ from a waste gas may be sequestered in a reaction product comprising carbonate, bicarbonate or a combination thereof, and a portion may be utilized to cultivate an agricultural product (e.g., algae).

In some embodiments algae may provide a source of alkalinity for reaction with a waste gas. As algae consume CO₂ dissolved in water during photosynthesis, the pH of the water or growth medium may rise. The pH of the water may rise from a neutral pH to greater than 8, or greater than 9 or greater than 10. In some embodiments an increased change in the pH may occur when divalent cation concentration is between 0 and 100 ppm, or between 0 and 50 ppm, or between 0 and 10 ppm. Under certain growth conditions the algae may cause the pH to rise to greater than 12. In some embodiments algae may be grown in a pond or tank (bioreactor) and a portion of the algae biomass may be removed and converted to biofuel while a portion of the growth medium may be siphoned off to add alkalinity to a carbon dioxide sequestration process. In some embodiments acid from an electrochemical process may be used to convert algae to a biofuel. In some embodiments the same electrochemical process may produce sodium hydroxide for use in carbon sequestration. The algae pond or tank may then be replenished with the nutrients the algae need to flourish. In some embodiments fast-growing blue-green algae may capable of raising the pH of their environmental waters to from neutral to 9.4 in time periods on the order of hours, such as less than 24 hours.

The components of biomass may include cellulose, hemicelluloses, lignin and oil. Cellulose is the most common form of carbon in biomass, accounting for 40%-60% by weight of the biomass, depending on the biomass source. It is a complex sugar polymer, or polysaccharide, made from the six-carbon sugar, glucose. Hemicellulose is also a major source of carbon in biomass, at levels of between 20% and 40% by weight. It is a complex polysaccharide made from a variety of five- and six-carbon sugars. While, the crystalline structure makes these materials it resistant to hydrolysis under neutral conditions, acid hydrolysis may beneficially promote hydrolysis to yield fermentable sugars from cellulose or hemicelluloses. Methods of this invention advantageously may provide sufficient quantities of acid for catalyzing the hydrolysis of these materials. In some embodiments acid solutions from an electrochemical process may be used to hydrolyze these materials into simple sugars. The sugars may then be fermented to form ethanol, or used in other reaction processes (e.g., furfural production).

Biomass may comprise vegetable fats, oils or other lipid materials derived from plants. Physically, oils may be liquid at room temperature, and fats may be solid. Chemically, both fats and oils are composed of triglycerides, as contrasted with waxes which lack glycerin in their structure. Any part of a plant may be used to yield oil. In some embodiments of this invention, oil may be extracted primarily from seeds. Although thought of as esters of glycerin and a varying blend of fatty acids, fats and oils also typically contain free fatty acids, mono- and di-glycerides, and unsaponifiable lipids. Vegetable fats and oils may be edible or inedible. Examples of inedible vegetable fats and oils useful for methods of this invention include processed linseed oil, tung oil, and castor oil. In some embodiments vegetable oil maybe refined into bio-diesel fuel using acid derived from an electrochemical process that is configured to not produce chlorine gas. In some embodiments waste vegetable oil produced mainly from industrial deep flyers in potato processing plants, snack food factories and fast food restaurants may be used in this invention. In some embodiments oils may be converted to biofuels, such as biodiesel via acid esterification or transesterification using acid solutions derived from an electrochemical process.

Electrochemical Methods and Systems

Herein, exemplary systems and methods are disclosed wherein sodium chloride solution may be used in one compartment between the anode electrolyte and cathode electrolyte to produce sodium hydroxide and/or sodium carbonate ions and/or sodium bicarbonate in the cathode electrolyte, and hydrochloric acid in the anode electrolyte. However, as will be appreciated by one ordinarily skilled in the art, the system and method are not limited to the use of sodium chloride solution as disclosed in these exemplary embodiments since the system and method are capable of using an equivalent salt solution, e.g., an aqueous solution of potassium sulfate and the like to produce an equivalent result. Similarly, in preparing the electrolytes for the system, it will be appreciated that water from various sources can be used including seawater, brackish water, brines or naturally occurring fresh water, provided that the water is purified to an acceptable level for use in the system. Therefore, to the extent that such equivalents embody the present system and method, these equivalents are within the scope of the appended claims.

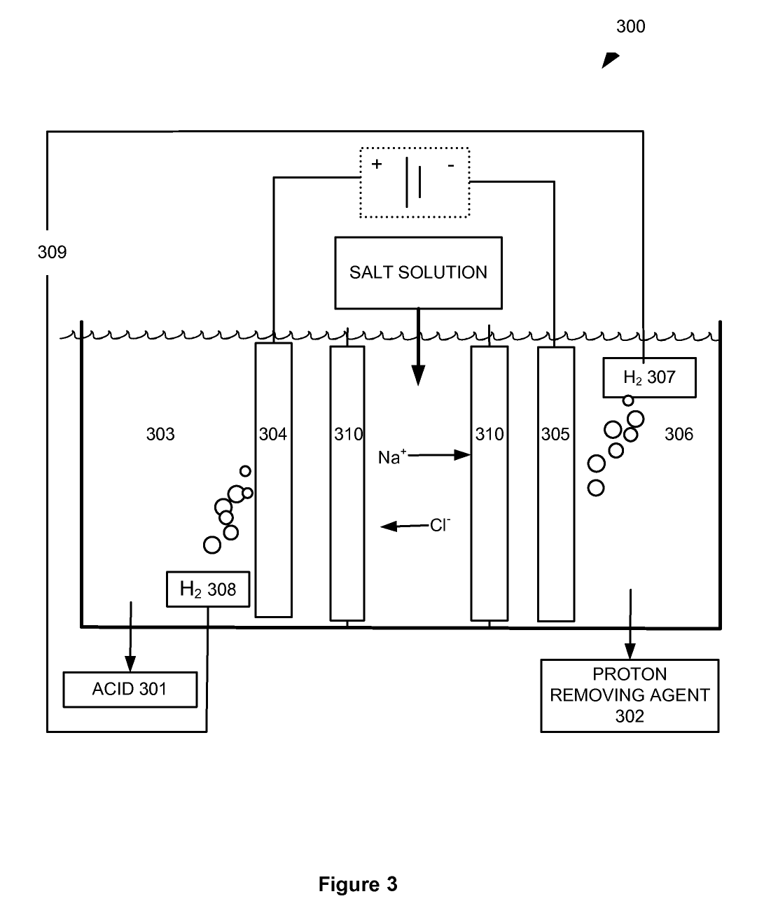

In some embodiments industrial quantities of alkaline hydroxides may be produced electrochemically from an aqueous salt solution. Thus, as described with reference to FIG. 3 herein, a proton removing agent 302 (e.g., sodium hydroxide) is produced by an electrochemical system 300 wherein in one embodiment at the cathode 305, water is reduced to a proton removing agent 302 and hydrogen gas 307 that migrates into the catholyte 306; and at the anode 304, hydrogen gas 308 is oxidized to acid 301 that migrates into the anolyte 303. In the system, by using ion exchange membranes 310 to separate the anolyte, catholyte and salt solution, and by applying a voltage across the anode 304 and cathode 305 an alkaline solution i.e., sodium hydroxide is produced in the catholyte and an acid i.e., is hydrochloric acid is produced in the anolyte or in an electrolyte separated from the anolyte by a cation exchange membrane. In some embodiments carbon dioxide is added to the catholyte to lower the cell voltage across the anode and cathode, and also to sodium bicarbonate and or sodium carbonate solution with the catholyte.

In some embodiments, an aqueous salt solution, e.g., sodium chloride solution, is electrolyzed to produce the alkaline solution comprising hydroxide ions in the catholyte in contact with the cathode, and hydrogen gas at the cathode, while minimizing the production of chlorine gas. Concurrently, protons produced by the oxidation at the anode migrate into the anolyte in contact with the anode to produce an acid, e.g., hydrochloric acid with cations from the salt solution. The system and method may be configured to operate at a voltage of 2.0 volts or less. Industrial amounts of an alkaline solution may be produced in electrochemical systems based on the chlor-alkali process or in a process that do not involve the generation of chlorine. Methods and systems used in sequestering the carbon dioxide include sodium hydroxide and/or sodium bicarbonate produced in an electrochemical process from a sodium chloride solution. In one embodiment of the electrochemical process, as described in commonly assigned U.S. Pat. No. 7,790,012 herein incorporated by reference, sodium hydroxide is produced in the cathode compartment and migration of sodium ions from the salt solution into the cathode compartment to produce sodium hydroxide in the catholyte in contact with the cathode,

2H₂O+2e⁻→H₂+2OH⁻ (Eq. VI)

In some embodiments the co-product hydrogen gas produced at the cathode may be recovered and used at the anode as described below. In the anode compartment, depending on which oxidation reaction occurs at the anode, either chlorine gas or hydrochloric acid may be produced based on equations VII and VIII.

2Cl⁻→Cl₂+2e− (Eq. VII)

H₂→2H⁺+2e− (Eq.VIII)

Where chlorine gas is produced as in Eq. VII, the gas can be recovered and used elsewhere; and where hydrogen is oxidized at the anode as in Eq. VIII, the hydrogen gas produced at the cathode as in Eq. VI may be used at the anode. Alternatively, hydrogen from an exogenous source may be used. In some embodiments hydrogen is oxidized to protons at the anode under the applied overall cell voltage, the protons migrate into the anolyte in contact with the anode and combine with chloride ions to produce hydrochloric acid. As used herein, the anolyte is the electrolyte in contact with the anode, and the catholyte is the electrolyte in contact with the cathode; thus the anolyte may migrate or supply anions to or from the anode and similarly the catholyte can migrate or supply ions to-or from the cathode.

As can be appreciated, in producing an alkaline solution as described above, the cost of the production is largely determined the overall cell voltage across the anode and cathode in the system. As used herein the overall cell voltage is the voltage required to achieve the redox reactions at the anode and cathode and to overcome ohmic resistance in the system to produce the products in the catholyte and anolyte. Thus, the overall cell voltage includes the half-cell redox reactions voltages at the electrodes and the voltage drops in the system due to ohmic resistances, the desired current density at the cathode, the temperature, pH and concentration of the electrolytes, the size of the inter-electrode gap, the presence of ion exchange membranes, diaphragms and other ionic barriers interposed between the electrodes to control the migration of ions in the system, and other design and operating parameters in the system.

One means by which the overall cell voltage may be reduced is not to produce a gas (e.g., chlorine, oxygen) at the anode, but rather to oxidize hydrogen at the anode to yield an acid. The method of this invention provides for utilizing acid produced by the electrochemical process described here to advantageously further increase the economic efficiency of the process. In some embodiments a method for generating sodium hydroxide includes interposing an ion exchange membrane between an anode compartment comprising a gas diffusion anode and a cathode compartment comprising a catholyte in contact with a cathode in an electrochemical system and positioning a percolator in the anode compartment between the gas diffusion anode and the ion exchange membrane and percolating an anolyte through the percolator thereby establishing an ionic pathway from the anode to the cathode through the anolyte, the ion exchange membrane and the catholyte. The method may include oxidizing hydrogen to protons at the gas diffusion anode and migrating the protons into the percolator while generating hydroxide ions and hydrogen at the cathode by applying a voltage across the gas diffusion anode and cathode and migrating anions from the catholyte into the anolyte to form an acid in the anolyte, or migrating cations from the anolyte into the catholyte to form an alkaline solution in the catholyte, through the ion exchange membrane and dissolving carbon dioxide in the catholyte to sequester the carbon dioxide as a carbonate and/or bicarbonate. In some embodiments, the hydrogen produced at the cathode may circulated to the anode to reduce the need for an external supply of hydrogen gas and hence reduce the overall energy utilized in the system to produce the alkaline solution.

In some embodiments, the sodium hydroxide is produced in the cathode electrolyte with a cell voltage of less than 2V is applied across the cathode and anode. Concurrently, the hydrogen provided to the anode is oxidized to protons that migrate in the anolyte where it combines with anions, e.g., chloride ions from the salt solution to produce an acid, e.g., hydrochloric acid in the anolyte. In methods of this invention utilization methods are described that may provide for increased economic efficiency of the electrochemical reaction.

In another embodiment, the present hydrogen anode assembly is described in greater detail in U.S. Pat. No. 5,595,641, titled: “Apparatus and Process for Electrochemically Decomposing Salt Solutions to form the Relevant Base and Acid”, herein incorporated by reference. In some embodiments, an electrolyzer comprising at least one elementary cell divided into electrolyte compartments by cation-exchange membranes, wherein said compartments are provided with a circuit for feeding electrolytic solutions and a circuit for withdrawing electrolysis products, and wherein said cell is equipped with a cathode and a hydrogen-depolarized anode assembly forming a hydrogen gas chamber fed with a hydrogen-containing gaseous stream, characterized in that said assembly comprises a cation-exchange membrane, a porous, flexible electrocatalytic sheet, a porous rigid current collector having a multiplicity of contact points with said electrocatalytic sheet, said membrane, sheet and current collector are held in contact together by means of pressure without bonding.

In some embodiments the electrochemical reaction may include interposing an ion exchange membrane between an anode compartment comprising a gas diffusion anode and a cathode compartment comprising a catholyte in contact with a cathode in an electrochemical system. The reaction may also include positioning a percolator in the anode compartment between the gas diffusion anode and the ion exchange membrane and percolating an anolyte through the percolator thereby establishing an ionic pathway from the anode to the cathode through the anolyte, the ion exchange membrane and the catholyte. In some embodiments the method provides for oxidizing hydrogen to protons at the gas diffusion anode and migrating the protons into the percolator while generating a proton removing agent and hydrogen at the cathode by applying a voltage across the gas diffusion anode and cathode and migrating anions from the catholyte into the anolyte to form the acidic solution in the anolyte.

In another embodiment, the present hydrogen anode membrane electrolysis cell comprising an anodic compartment and a cathodic compartment is described, wherein at least one of the two compartments contains an electrode fed with gas and a porous planar element is interposed between the membrane and the gas-fed electrode. A flow of chemically aggressive electrolyte crosses the porous planar element downwards under the effect of the gravity force. The planar element consists in a plastic element withstanding the aggressive operative conditions: The use of perfluorinated plastics such as ECTFE, PTEFE, FEP, PFA is preferred, even though they are strongly hydrophobic. When the gas-fed electrode is a cathode and the gas contains oxygen, the gas crosses the cathodic compartment upwardly so as to minimize the risk of hydrogen build up. The cell equipped with the oxygen cathode is particularly advantageous for the sodium chloride electrolysis assembly is described in greater detail in U.S. Pat. No. 6,444,602, titled: “Structures and Methods for Gas Diffusion Electrodes and Electrode Components”, herein incorporated by reference.

Another embodiment of the present hydrogen anode membrane assembly is provided in U.S. Pat. No. 5,985,197, titled: “Catalysts For Gas Diffusion Electrodes”, herein incorporated by reference.

Biofuels and Furfural Methods and Systems

Biofuel as used herein includes materials derived from plant or animal matter that may be used as a fuel source, usually in contrast to fossil fuel, which indicates a fuel such as coal or petroleum oil. Biofuels include solids that are burned for fuel, such as wood or animal waste; gases, such as methane derived from animal sources or syngas produced from burning biofuel solids; or liquids that have been created from biomass, such as bioethanol and biodiesel. Sources of biofuels include, but are not limited to: paper waste, wood waste, forest waste, miscanthus, sorghum, hybrid poplar trees, winter cover crops, perennial crops with deep roots, switchgrass, timber harvesting residues, corn stover, sawdust, paper pulp, hog manure, municipal garbage that can be converted into cellulosic ethanol, sugar feedstocks (e.g., sugarcane, sugar beets), and starchy feedstocks (e.g., cereal grains, potato, sweet potato, cassava, maize, wheat etc..) algae, seed crops (e.g., soybean, cotton seed, rapeseed etc..). Liquid biofuels are of increasing interest as governments strive to reduce the dependence of their nations on fossil fuel based oil. Biodiesel is a form of fuel that can be used in standard diesel engines alone or blended with conventional fuel. Biodiesel is typically made by the transesterification of vegetable oil or animal fat feedstock. In some embodiments, the vegetable oil used in methods of this invention is derived from from palm trees. Bioethanol is another biofuel that may be blended with conventional fuel or used independently in engines that are adapted to accept such fuel.

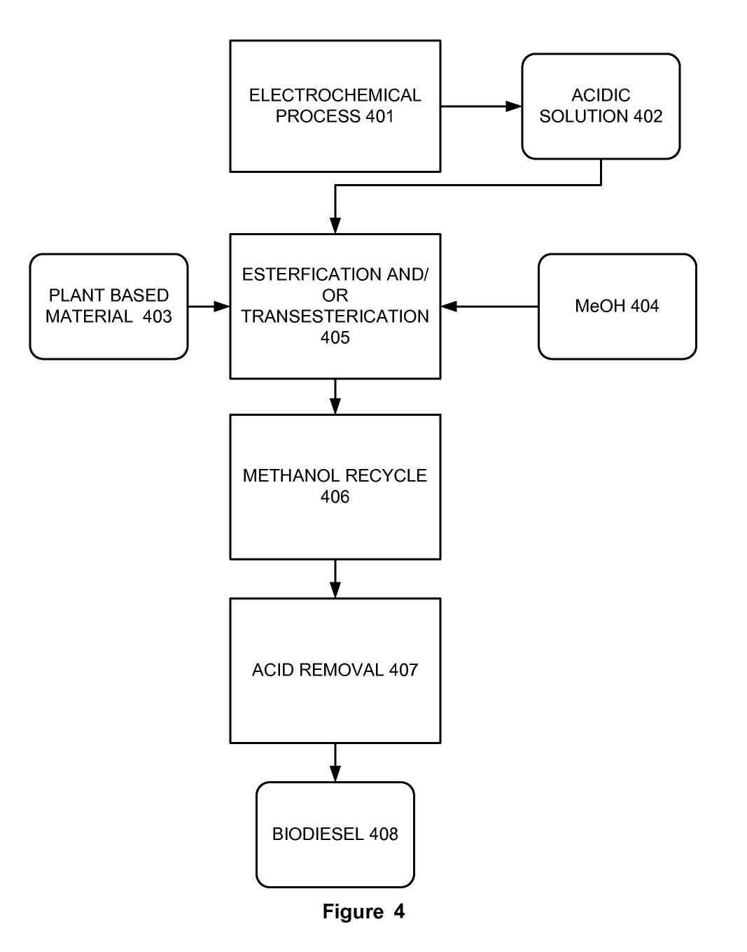

Biodiesel is a nonpetroleum-based fuel that may comprise alkyl esters derived from either the transesterification of triglycerides (TGs) or the esterification of free fatty acids (FFAs) with low molecular weight alcohols (e.g., plant oils, waste cooking oils, nut oils). In some embodiments the plant oil has a free fatty acid concentration of greater than 6%. The flow and combustion properties of biodiesel are similar to petroleum-based diesel and, thus, can be used either as a substitute for diesel fuel or optionally in fuel blends. Biodiesel production may utilize either a base or acid catalyzed reaction process. Acid-catalyzed transesterifications hold an important advantage with respect to base-catalyzed ones: the performance of the acid catalyst is not strongly affected by the presence of free fatty acids (FFAs) in the feedstock. In fact, acid catalysts may simultaneously catalyze both esterification and transesterification. Thus, an advantage of acid solutions of this invention is it may provide a low cost source of acid to directly produce biodiesel from low-cost lipid feedstocks, generally associated with high FFA concentrations. A simplified block flow diagram of a typical acid-catalyzed process is shown in FIG. 4 illustrating the steps in biodiesel production. An acidic solution 402 is produced from an electrochemical process 401 (e.g., an electrochemical process that does not produce chlorine gas). The acidic solution 402 may be combined with a plant based material 403 and methanol 404 to catalyze an esterification or transesterification reaction 405 with glycerides present in the plant material 403. In some embodiments the plant based material may have a free fatty acid content of greater than 6%. Methanol recovery and recycling 406 followed by acid removal 407 may yield a biodiesel product 408 that is useful as a fuel either alone or in combination with conventional petroleum fuels. In some embodiments acid removal may include neutralization of the acid using a salt such as calcium oxide. In some embodiments the method of this invention uses acid derived from an electrochemical process that also produces a proton removing agent. This method may advantageously allow for the economical conversion of plant based materials into a biofuel by providing an inexpensive source of acid, while providing a reagent for the sequestration of carbon dioxide.

Bioethanol may be produced by using various types of biomass. The types of biomass include sugar feedstock, starchy feedstock, or cellulosic feedstock. Sugar feedstock, such as sugarcane, and starchy feedstock, such a potatoes, maize, and wheat, are also food sources, and increasingly expensive and inefficient when calculating the amount of energy to cultivate and harvest the feedstock versus the amount of fuel produced. Cellulosic feedstocks for bioethanol production are fibrous plant material such as paper, cardboard, saw dust, grasses, and are often looked upon as waste materials of other processes and are not needed as sources of food. Bioethanol from cellulose sources may be obtained using acid hydrolysis, enzymatic hydrolysis, and thermochemical processing. In the acid processing, almost any acid may be of use, such as hydrochloric acid. In some embodiments, sugar feedstock is used as the biomass for the biofuel production process. In some embodiments, cellulosic feedstock is used as the biomass for the biofuel production process. In some embodiments, the system for biofuel production is configured to accept an acid solution from an electrochemical system configured to prevent the release of chlorine gas. In some embodiments, the system for biofuel production is configured to accept sugar feedstock. In some embodiments, the system for biofuel production is configured to accept cellulosic feedstock. These plant materials may contain the polysaccharide hemicellulose, a polymer of sugars containing five carbon atoms each. Hemicelluloses found in these feedstocks may undergo hydrolysis when heated with acid, to yield these sugars, principally xylose. The sugars may then be fermented to produce ethanol. Under the same conditions of heat and acid, xylose and other five carbon sugars undergo dehydration, losing three water molecules may be converted to furfural.

Furfural is an organic compound derived from a variety of agricultural byproducts, including corncobs, oat, wheat bran, and sawdust. Chemically, furfural participates in the same kinds of reactions as other aldehydes and other aromatic compounds. Indicating its diminished aromaticity relative to benzene, furfural is readily hydrogenated to the corresponding tetrahydrofuran derivatives. When heated in the presence of acids, furfural irreversibly may solidify into a hard thermosetting resin. For crop residue feedstocks, about 10% of the mass of the original plant matter may be recovered as furfural using acid hydrolosis. Furfural and water evaporate together from the reaction mixture,-and separate upon condensation. Furfural may be used as a solvent in petrochemical refining to extract dienes (which are used to make synthetic rubber) from other hydrocarbons. Furfural, as well as its derivative furfuryl alcohol, may be used either by themselves or together with phenol, acetone, or urea to make solid resins. Such resins are used in making fiberglass, some aircraft components, and automotive brakes. Furfural is also an intermediate in the production of the solvents furan, 2-methyltetrahydrofuran, and tetrahydrofuran.

Acid hydrolysis to produce bioethanol or furfural may employ either dilute acid or concentrated acid. Dilute acid may have of a concentration around 1-10 wt %. Dilute acid processes may take place at elevated temperatures (above 200° C.) and in some cases elevated pressure, but also occur quickly, in a matter of minutes or seconds to produce sugars for fermentation from cellulose. Concentrated acid processes use acid of concentration that may vary during the process from as low as about 10 wt % up to 70 wt % or more. Concentrated acid processes may occur at moderate temperature (around 100° C.). In some embodiments the temperature of the acid may be greater than 40° C. In some embodiments the heat generated in the electrochemical process may be used to accelerate a reaction in a biofuel synthesis process. In some embodiments pressure may be applied to move the material through the reaction vessels. In contrast to the dilute acid process, the concentrated acid processes may occur over a longer period of time such as hours or days. In some embodiments, the production of biofuel comprises the use of hydrochloric acid (HCl) derived from an electrochemical process that minimizes the production of chlorine gas. The hydrochloric acid may be any concentration. In some embodiments, the production of biofuel comprises the use of dilute acid of concentration 10 wt % or less. In some embodiments, the production of biofuel comprises the use of dilute acid of concentration 5 wt % or less, such as 3 wt % or less, 2 wt % or less, or 1 wt % or less. In some embodiments, the production of biofuel comprises the use of concentrated acid. In some embodiments, the production of biofuel comprises the use of concentrated acid of concentration 10 wt % or more. In some embodiments, the production of biofuel comprises the use of concentrated acid of concentration 15 wt % or more, such as 20 wt % or more, 25 wt % or more, 30 wt % or more, 35 wt % or more, 40 wt % or more, 45 wt % or more, 50 wt % or more, 60 wt % or more, or 70 wt % or more. In some embodiments, the production of biofuel comprises the use of concentrated acid of concentration 36 wt % or more. In some embodiments, the production of biofuel comprises the use of concentrated acid of concentration 37 wt % or more. In some embodiments, the production of biofuel comprises the use of concentrated acid of concentration 38 wt % or more. In some embodiments, the production of biofuel comprises the use of concentrated acid of concentration 40 wt % or more. In some embodiments, the production of biofuel comprises the use of concentrated acid of concentration 42 wt % or more. In some embodiments, the production of biofuel comprises the use of fuming acid. In some embodiments the acid may be used directly from the electrochemical process or may be concentrated or diluted as needed.

Methods of this invention may include enzymatic hydrolysis after employing dilute acid in a pretreatment step. Microorganisms may then be utilized to affect the hydrolysis of the cellulose and hemicellulose of the feedstock. Lignin that is separated from the cellulose and hemicellulose following acid-pretreatment may be used to power the biofuel production activities. In enzymatic hydrolysis, the process time may be days or weeks to achieve good results. In some embodiments, the production of biofuel includes the use of enzymes before or after acid hydrolysis. In some embodiments, the production of biofuel comprises the use of enzymes to create cellulosic ethanol. In some embodiments, the production of biofuel excludes the use of enzymes. In some embodiments, the production of biofuel comprises the use of concentrated acid and excludes the use of enzymes. One method of bioethanol production involves the thermochemical gasification of biomass that is then turned into synthesis gas (or syngas) that is then bubbled through special fermenters. The syngas is reacted with specific microorganisms capable of transforming the syngas to ethanol. A second method gasifies the biomass. The syngas is then passed through a reactor containing catalysts which cause the conversion of the gas into ethanol. In some embodiments, the production of biofuel comprises the gasification of biomass. In some embodiments, the production of biofuel comprises the gasification of biomass and the production of ethanol. In some embodiments, the production of biofuel comprises the gasification of biomass and the production of ethanol with the use of microorganisms. In some embodiments, the production of biofuel comprises the gasification of biomass and the production of ethanol excluding the use of microorganisms. In some embodiments, the production of biofuel comprises the gasification of biomass and the production of ethanol with the use of catalysts.

In some embodiments, methods of this invention may comprise sequestering carbon dioxide in a plant material and sequestering carbon dioxide from an industrial waste gas and calculating the amount of carbon dioxide sequestered in both of these processes. Reagents for the sequestration or utilization of the carbon sequestered may be produced by the same electrochemical process. In some embodiments the amount of carbon dioxide sequestered in a plant material may include determining the dry weight of the plant material and determining the average carbon content of the plant material based on the type of plant material utilized (e.g., for deciduous trees, the carbon content is generally 50% of the dry weight of the tree). In some embodiments the amount of carbon dioxide sequestered from an industrial waste gas may be determined by contacting a waste gas with a proton removing agent and sequestering the carbon dioxide present in the waste gas in a reaction product comprising carbonate, bicarbonate or any combination thereof and then measuring the amount of carbon present in the reaction product using methods known in the art for measuring carbon content. Any suitable technique for the measurement of carbon may be used, such as coulometry. Carbon measurements may be used in some cases to quantitate the amount of carbon dioxide sequestered in a composition. While the carbon dioxide sequestered in a plant based material may be ultimately released by the combustion of the biofuel generated from the material, the carbon dioxide released represents carbon dioxide sequestered from the atmosphere advantageously replacing the combustion of a portion of fossil fuel. Isotope measurements may be used to verify that the source of the carbon in a composition is what it is claimed to be. Thus the sequestration of carbon dioxide in a reaction product comprising carbonate, bicarbonate or any combination thereof and a biofuel or furfural advantageously provides for a carbon sequestration method that results in the reduced release of carbon dioxide into the atmosphere.

### EXAMPLE I

The following protocol may be used to produce a biofuel. HCl is be generated by an electrochemical method such as the method illustrated in FIG. 3 that is configured to avoid the production of chlorine gas. The HCl is generated at 70° C. and 10 wt %. The HCl is transferred via an insulated, acid resistant conduit system to a vessel containing biomass such as such as sugar cane. HCl catalyzes the breakdown of sugarcane into fermentable sugars such as glucose. Heat from the electrochemical reaction may be used accelerate the HCl catalysis reaction. Fermentation occurs in a separate vessel and the biomass is converted to bioethanol. The HCl is removed by neutralization with a neutralization agent such as CaO.

While preferred embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

That which is claimed is;:

1. A method of utilizing reagents from an electrochemical reaction comprising:
a) generating a proton removing agent and an acidic solution in an electrochemical reaction;
b) sequestering a first portion of carbon dioxide from a waste gas in an aqueous solution by contacting the waste gas with the proton removing agent; and
c) contacting a plant based material and the acidic solution in a reaction mixture to catalyze at least one step of a chemical synthesis.

2. The method of claim 1, further comprising sequestering a second portion of carbon dioxide from the atmosphere in the plant based material via photosynthesis; and
calculating the sum of carbon dioxide sequestered in the first and second portion.

3. A method of utilizing reagents from an electrochemical reaction comprising:
a) generating a proton removing agent and an acidic solution in an electrochemical reaction;
wherein the electrochemical reaction comprises oxidizing hydrogen gas at an anode; and
b) contacting a plant based material and the acidic solution in a reaction mixture to catalyze at least one step of a chemical synthesis.

4. The method of claims 1 and 3, wherein the chemical synthesis comprises the synthesis of a biofuel.

5. The method of claims 1 and 3, wherein the chemical synthesis reaction comprises the synthesis furfural.

6. The method of claims 1 and 3, wherein electrochemical reaction operates at a voltage of 2.0 volts or less.

7. The method of claims 1 and 3, wherein the pH of the acidic solution is less than 1.

8. The method of claims 1 and 3, wherein the electrochemical reaction is configured to avoid production of chlorine gas.

9. The method of claims 1 and 3, wherein the electrochemical reaction comprises;
a) interposing an ion exchange membrane between an anode compartment comprising a gas diffusion anode and a cathode compartment comprising a catholyte in contact with a cathode in an electrochemical system;
b) positioning a percolator in the anode compartment between the gas diffusion anode and the ion exchange membrane and percolating an anolyte through the percolator thereby establishing an ionic pathway from the anode to the cathode through the anolyte, the ion exchange membrane and the catholyte;
c) oxidizing hydrogen to protons at the gas diffusion anode and migrating the protons into the percolator while generating a proton removing agent and hydrogen at the cathode by applying a voltage across the gas diffusion anode and cathode;
d) migrating anions from the catholyte into the anolyte to form the acidic solution in the anolyte.

10. The method of claims 1 and 3, wherein the acidic solution comprises an acid selected from hydrochloric acid, sulfuric acid, acetic acid, hydrofluoric acid, hydrobromic acid and nitric acid.

11. The method of claims 1 and 3, wherein the proton removing agent is sodium hydroxide.

12. The method of claims 1 and 3, wherein the plant based material comprises lignocellulosic material.

13. The method of claims 1 and 3, wherein the plant based material comprises plant oil.

14. The method of claims 1 and 3, wherein the chemical synthesis catalyzed comprises a chemical reaction selected from the group of transesterification, esterificaton and hydrolysis.

15. The method of claim 14, wherein the esterificaton comprises the esterificaton of free fatty acids.

16. The method of claim 14, wherein the transesterification reaction comprises the transesterification triglycerides.

17. The method of claim 14, wherein the transesterification reaction comprises transesterification of plant oil.

18. The method of claim 17, wherein the plant oil comprises used cooking oil.

19. The method of claim 17, wherein the plant oil has a free fatty acid concentration of greater than 6%.

20. The method of claims 5 and 12, wherein the chemical synthesis comprises digesting the lignocellulosic without the use of an enzyme.

21. The method of claim 1, further comprising precipitating a carbonate containing compound from the aqueous solution.

22. The method of claim 21, wherein the precipitating comprises contacting the aqueous solution with a divalent cation.

23. The method of claim 1, further comprising converting the acidic solution to a vapor prior to contacting with the plant based material.

24. The method of claims 1 and 3, wherein the concentration of the acidic solution is between 0.5 and 30.0 wt %.

25. The method of claims 1 and 3, further comprising raising the pH of the reaction mixture after the catalyzing of the chemical synthesis.

26. A system comprising;
a) an electrochemical system for generating a proton removing agent and acidic solution in an electrochemical reaction;
b) a first reaction vessel operably connected to the electrochemical system for sequestering a first portion of carbon dioxide from a waste gas configured to contact an aqueous solution comprising the proton removing agent with the waste gas comprising carbon dioxide; and
c) a second reaction vessel operably connected to the electrochemical system for contacting a plant based material and the acidic solution to catalyze a chemical reaction.

27. The system of claim 26, wherein the second reaction vessel is configured to synthesize a biofuel.

28. The system of claim 26, wherein the second reaction vessel is configured to synthesize a furfural.

29. The system of claim 26, wherein the electrochemical system is configured to operate at a voltage of 2.0 volts or less.

30. The system of claim 26, wherein the electrochemical system is configured to avoid production of chlorine gas.

31. The system of claim 26 wherein the electrochemical system comprises;
a) an ion exchange membrane interposed between an anode compartment comprising a gas diffusion anode and a cathode compartment comprising a catholyte in contact with a cathode;
b) a percolator positioned in the anode compartment between the gas diffusion anode and the ion exchange membrane and configured to percolate an anolyte axially through the percolator;
c) a voltage supply connected to the anode and cathode and operable to cause: oxidation of hydrogen to protons at the gas diffusion anode; migration of anions from the catholyte into the anolyte or migration of cations from the anolyte into the catholyte, through the ion exchange membrane; migration of the protons into the percolator to produce an acid in the anolyte in the percolator; and generation of hydroxide ions and hydrogen at the cathode to form an alkaline solution in the catholyte; and
d) a source of carbon dioxide configured to dissolve carbon dioxide to the catholyte and sequester the carbon dioxide as a carbonate and/or bicarbonate.

32. The system of claim 26, wherein the synthesis catalyzed in the second reaction vessel is configured to comprise a chemical reaction selected from the group of containing transesterification, esterification and hydrolysis.
